(19) United States
(12) Patent Application Publication
(10) Pub. No.: US 2013/0077162 A1
(43) Pub. Date: Mar. 28, 2013

(54) WATERGLOBE WITH THE ANIMATION EFFECT OF OPTICAL ILLUSIONS

(71) Applicant: Jack LIU, HsinChu City (TW)

(72) Inventor: Jack LIU, HsinChu City (TW)

(21) Appl. No.: 13/241,791

(22) Filed: Sep. 23, 2011

(51) Int. Cl. G02B 27/22

(52) U.S. Cl. 359/478

(57) ABSTRACT

A waterglobe with the animation effect of optical illusions is disclosed. Transparent black-n-white stripes and the complementary stripes of objects on a sheet of paper are made into an animation due to optical illusions. Combining with the basic structure of a waterglobe, the animation effect of optical illusions is displayed on the waterglobe to increase the fun thereof.

### BACKGROUND OF THE INVENTION

1. Field of Invention

The invention relates to a decorating waterglobe and, in particular, to a waterglobe with the animation effect of optical illusions.

2. Related Art

The basic structure of a waterglobe includes a transparent waterglobe that has theme ornamental objects such as trees, houses, castles, or cartoon characters. To increase the variety and fun or dynamical presentation of the ornamental objects in the waterglobe, ornamental waterglobes with dynamical effects have become a trend. The base of the waterglobe is disposed with a music core driven by an electrical motor or a manually fastened spring. The power is transmitted via a transmission mechanism such as gears or magnets to dynamically rotate ornamental objects, thereby improving the visual effects of the waterglobe. The music core plays a beautiful melody at the same time, presenting desirable acoustic effects.

Since the ornamental waterglobe with dynamical effects has become the mainstream on the market, how to increase the novelty of visual effects is doubtless one of the main topic in the field. With continuous research and improvement, the inventor has many inventions along this line in recent years, such as the rotating base with continuous animation effects for the ornamental waterglobe or decoration disclosed in PROC Pat. No. 200520142807.5, the landscape model combined to the interior and exterior of a crystal ball disclosed in PROC Pat. No. 03208540.0, the driving device for the snow scene in a crystal ball disclosed in PROC Pat. No. 03244727.2, and the ornamental crystal ball with embossment effects disclosed in PROC Pat. No. 03244726.4.

The optical illusion is a visual illusion produced through certain geometrical arrangements of text or graphics, in combination with variations in brightness, angle, color, and motion. This renders interesting fake image effects. The animation produced using the optical illusions makes use of transparent BW strips and complementary object stripes on a GS. The stripes on the GS produce an illusion effect that makes a person think that the object on the GS is moving.

The inventor thinks that implementing the above-mentioned animation effect with optical illusions on a waterglobe will be a breakthrough in the visual effect thereof. Therefore, the inventor proposes the present waterglobe with an animation effect of optical illusions.

### SUMMARY OF THE INVENTION

To achieve the above-mentioned objectives, the invention integrates the basic structure of a conventional waterglobe and an optical illusion component. The optical illusion component includes a BW GS and an object GS. The BW GS disposed in the front is held still, whereas the object GS disposed in the back is continuously moved. The transparent BW grating and the complementary object stripes on the GS render an illusive effect that the object is moving.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 shows an embodiment of implementing the optical illusion animation effect on a globe according to the invention;

FIG. 2 shows an embodiment of implementing the optical illusion animation effect on a base according to the invention; and

FIG. 3 is an expanded view of the BW grating GS and the object GS.

### DETAILED DESCRIPTION OF THE INVENTION

The present invention will be apparent from the following detailed description, which proceeds with reference to the accompanying drawings, wherein the same references relate to the same elements.

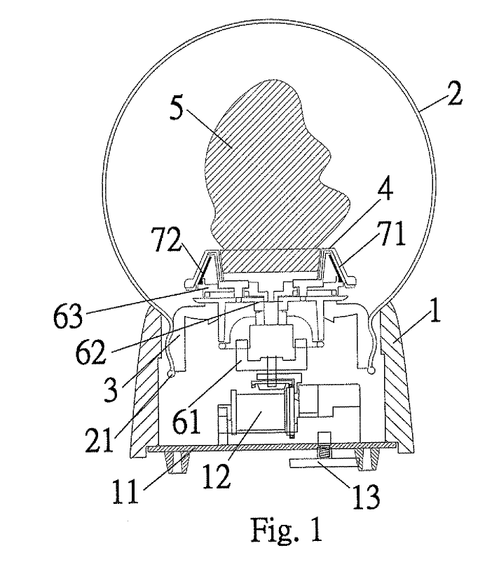

Please refer to the ornamental waterglobe in FIG. 1. Its basic structure includes: a base 1, a globe 2, a support platform 4, and a transmission mechanism.

The bottom 11 of the base 1 has a power source 12. It is usually composed of an electrical motor (not shown) or a mechanical energy-storing device (i.e., a usual music core) with a spring that is fastened manually. The globe 2 is disposed on the base 1 and filled with a liquid. Its opening part 21 is sealed by a rubber cork 3. The support platform 4 is disposed with a theme view 5. The transmission mechanism is interposed between the power source 12 and the support platform 4. It includes several sets of transmission gears 61, connecting elements 62, and dials 63. The function of the transmission mechanism is to transmit power to the support platform 4 so that the theme view 5 performs a rotation or other dynamical effect. Since the transmission mechanism belongs the prior art and has been widely used in the waterglobe industry, it is not further described herein.

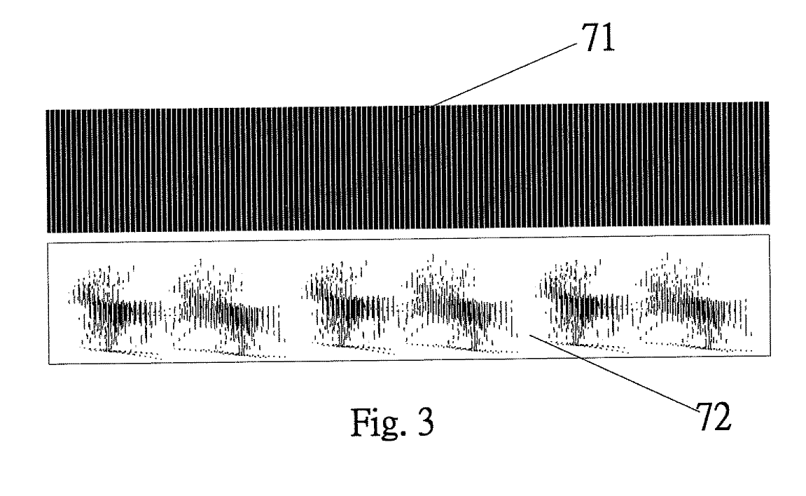

The invention is featured in the combination of the above-mentioned basic structure of waterglobe and an optical illusion component. Please refer to FIG. 3. The optical illusion component includes a BW stripe GS 71 and an object GS 72. As the 13W grating disposed in the front is held still, the object GS in the back is continuously moved. The transparent 13W grating stripes and the object stripes on the GS are complementary in such a way that the object on the object GS seems to be moving.

The animation effect of the above-mentioned optical illusion can be implemented on the globe 2 or on the base 1.

As shown in FIG. 1, the optical illusion animation effect is implemented on the globe 2 in this embodiment. The BW grating GS 71 is disposed at an appropriate location on the support platform 4. The object GS 72 is disposed on a dial 63 of the transmission mechanism in parallel to the BW grating GS 71. The support platform 4 is held still, whereas the dial 63 with the object GS 72 is driven by the power source 12 to rotate, The desired optical illusion animation effect is then produced.

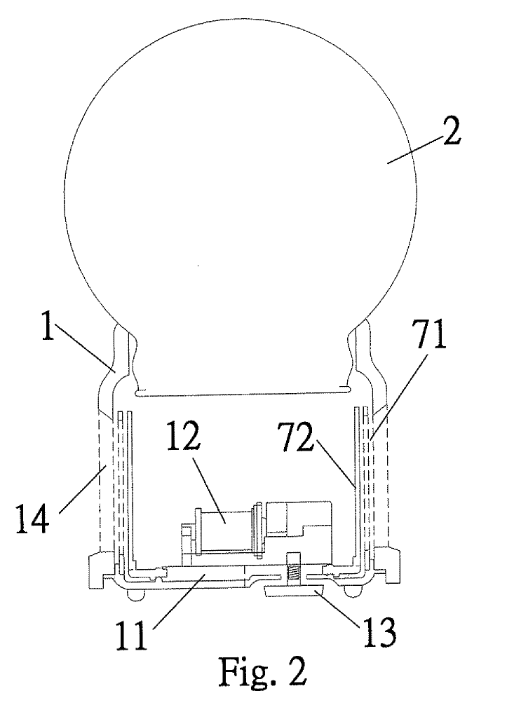

FIG. 2 shows another embodiment in which the optical illusion animation effect is implemented on the base 1. A window 14 is formed around the base 1. Behind the window stands the 13W grating GS 71. The object GS 72 is then disposed behind and in parallel to the 13W grating GS 71. The 13W grating GS 71 is fixed. But the location of the object GS is driven by the power source 12 to rotate, thereby producing the optical illusion animation effect.

In summary, the complementarity of the BW grating stripes and object stripes on the object GS produces an animation effect due to optical illusions. In combination with the basic structure of a waterglobe, the above-mentioned optical illusion animation effect can be implemented thereon to increase the fun.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A waterglobe with an animation effect of optical illusions, comprising:
a base, whose bottom is provided with a power source;
a ball disposed on the base;
a support platform for the placement of a theme view;
a transmission mechanism disposed between the power source and the support platform to transmit power and rotate the theme view or produce other dynamical effects; and
an optical illusion component, including a black-n-white graphic sheet and an object graphic sheet;
wherein the 13W GS is disposed at an appropriate location on the support platform, the object GS is disposed at an appropriate location on the transmission mechanism in parallel to the BW GS; the support platform is held still, and the object GS is driven by the power source to rotate.

2. The waterglobe with an animation effect of optical illusions as in claim 1, wherein the power source is a mechanical energy-storing device with a spring.

3. The waterglobe with an animation effect of optical illusions as in claim 1, wherein the transmission mechanism includes at least a set of transmission gears, connecting elements, and dials.

4. A waterglobe with an animation effect of optical illusions, comprising:
a base, whose bottom is disposed with a power source and whose surrounding is formed with a window;
a ball disposed on the base; and
an optical illusion component, including a black-n-white graphic sheet and an object graphic sheet;
wherein the BW GS is disposed behind the window around the base, the object GS is disposed behind and in parallel to the BW GS; the location of the BW GS is fixed, and the object GS is driven by the power source to rotate.

5. The waterglobe with an animation effect of optical illusions as in claim 4, wherein the power source is an electrical motor.

6. The waterglobe with an animation effect of optical illusions as in claim 4, wherein the power source is a mechanical energy-storing device with a spring.
